(19) United States
(12) Patent Application Publication
(10) Pub. No.: US 2007/0083922 A1
(43) Pub. Date: Apr. 12, 2007

(54) Network session re-construction

(76) Inventor: Richard Reiner, Toronto (CA)

Correspondence Address: ECKERT SEAMANS CHERIN & MELLOTT, 600 GRANT STREET, 44TH FLOOR, PITTSBURGH, PA, 15219, US

(21) Appl. No.: 10/580,486

(22) PCT Filed: Nov. 23, 2004
(86) PCT No.: PCT/CA04/02012

§ 371 Date: May 24, 2006

Related U.S. Application Data
(60) Provisional application No. 60/524,036, filed on Nov. 24, 2003.

(51) Int. Cl. G06F 15/16

(52) U.S. Cl. 726/12

(57) ABSTRACT

Rather than placing a service providing entity in series with a computer application, the service provider is placed in parallel with the application. This is achieved by a session re-constructor which creates a parallel session with the service provider to mirror each session with the application.

### BACKGROUND OF INVENTION

This invention relates to re-constructing sessions on a computer network.

In computer networks, information is conventionally transmitted in the form of packets. The information flow is typically in the form of a request made to a computer application and a reply by the application to the request. If the packets arrive from an untrusted source, such as the public Internet, there is a risk that they comprise or contain an illegitimate request to the computer application. Such an illegitimate request may constitute an unauthorised attempt to access proprietary information, an unauthorised attempt to alter information, or an attempt to interfere with the normal operations of the application (a so-called “denial of service attack”).

An application on a computer may be shielded from illegitimate requests by a computer firewall which filters packets destined for the application. More particularly, the firewall inspects packets and either passes them to the application or drops them depending upon whether they conform to a set of predefined access rules. Known packet filtering firewalls may apply rules to the packet headers of one or more of the link layer, network layer, and transport layer in order to verify the protocols used.

Another approach to shielding an application from illegitimate requests is to employ a proxy firewall. A proxy firewall acts as the destination for packets arriving through a public network and strips off the overhead from each packet that was used in directing the packet through the public network. With this approach, any attacks using the network overhead of packets are avoided. Known proxy firewalls may also apply rules to verify the application protocol.

The sophistication of illegitimate requests to computer applications continues to increase. The response is to provide firewalls with ever increasingly sophisticated techniques to screen requests. Additionally, the volume of traffic over the public Internet, and hence to computer applications accessible over the public Intemet, continues to increase. The result of both of these trends is that firewalls can increasingly become bottlenecks, slowing the apparent response time of a computer application. Furthermore, reliability problems with the firewall may negatively impact the reliability of the computer application—e.g., if the firewall crashes, the computer application may become unavailable.

In one aspect, this invention seeks to overcome drawbacks of known approaches to screening computer applications from illegitimate requests. More generally, this invention seeks to allow for the provision of services in respect of a computer application without causing a bottleneck and without reducing the reliability of the computer application.

### SUMMARY OF INVENTION

Rather than placing a service providing entity in series with a computer application, the service provider is placed in parallel with the application. This is achieved by a session re-constructor which creates a parallel session with the service provider to mirror each session with the application.

For example, the service provider may be a screen for illegitimate requests. In such case, when the screen determines that a request is illegitimate, it may take appropriate action, such as sending a session termination command. This command, generated in the parallel session, is then injected into the original session by the session re-constructor and sent to both endpoints. As another example, the service provider could be a record keeper which retains the contents of messages, such as e-mail messages, or instant messages, for regulatory compliance or law enforcement. As a further example, the service provider could be a de-bugger which monitors and re-constructs network communications for the purpose of identifying and correcting operational problems.

In accordance with the present invention, there is provided a method for use in a session-oriented network, comprising for each session with a given endpoint, said each session comprising packets exchanged between said given endpoint and another endpoint, said packets having one or both of control and payload data, creating a parallel session having payload data mirroring all payload data of said each session which is destined for said given endpoint. A computer readable medium containing computer executable instructions for causing a processor connected into a session-oriented network to undertake the method is also provided.

In accordance with another aspect of this invention, there is provided a session re-constructor, comprising: an interface for connection to a session-oriented network; an interface for connection to a given endpoint; a processor for, for each session with said given endpoint, said each session comprising packets exchanged between said given endpoint and another endpoint, said packets having one or both of control and payload data, creating a parallel session having payload data mirroring all payload data of said each session which is destined for said given endpoint.

Other features and advantages will become apparent by reference to the following description in conjunction with the drawings.

### BRIEF DESCRIPTION OF THE DRAWINGS

In the figures which illustrate example embodiments of the invention,

FIG. 1 is a schematic diagram of a network configured in accordance with this invention,

FIG. 2 is a schematic detail view of a session re-constructor of FIG. 1, and

FIG. 3 is a schematic diagram of a TCP segment.

### DETAILED DESCRIPTION

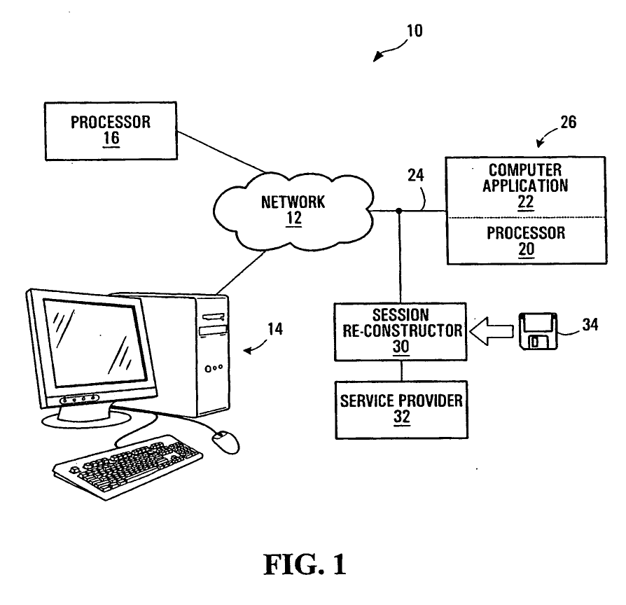

Turning to FIG. 1, a computer network 10 constructed in accordance with this invention, comprises a network 12, such as a public Internet or a private enterprise network. A number of endpoints, such as personal computers 14 and other processors 16 are connected to the network 12. An endpoint 26 which is a computer application 22 running on a processor 20 is connected to the network via communication path 24. A session re-constructor 30 is also connected to communication path 24, and a service provider 32 is connected to the session re-constructor. The session reconstructor may be configured for operation with software from computer readable medium 34 which may, for example, be a disc, a read only memory, or a file downloaded from a remote source.

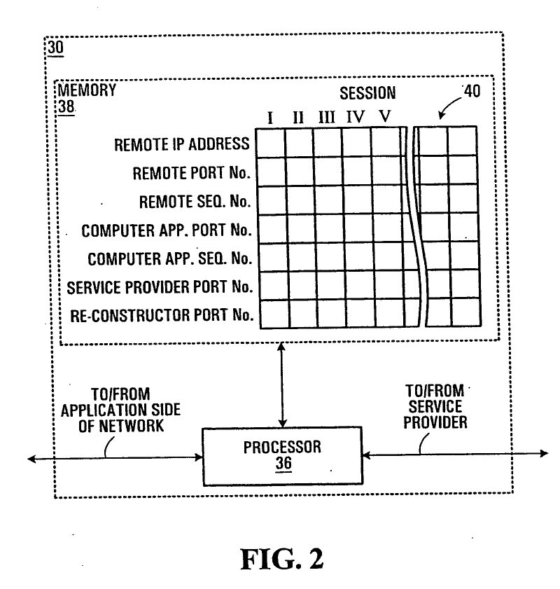

As seen in FIG. 2, the session re-constructor comprises a processor 36, which is connected to both the communication path 24 and the service provider, and a memory 38. For reasons which will become apparent, memory 38 holds a table 40 with certain information on sessions with computer application 22.

As is usual, the computer network 10 is a packet-oriented network. Packets transmitted across the network 12 comprise a top level link layer, a mid-level network layer, a lower level transport layer, and a low level application layer. At each layer, packet-like entities are nested within the envelope provided by the lower layers. Thus, the link layer is a packet with a header and data that comprises a network layer packet and the network layer packet has a header and data that comprises a transport layer packet. The header of the link layer almost invariably indicates that the protocol followed by the packet is the Internet Protocol (IP) (older protocols being now substantially obsolete, and in any event, not in use on the public Internet). Where the packet is an IP packet, the network layer is known as an IP datagram. The header of the transport layer will indicate the transport protocol, the Transmission Control Protocol (TCP) of the IP being by far the most common transport protocol as it is used for web browsing, e-mail, and web services. (As will be appreciated by those skilled in the art, web services are machine-to-machine interactions whereby one application may make requests of another application). Other, much less frequently used transport protocols include User Datagram Protocol (UDP) and Stream Control Transmission Protocol (SCTP).

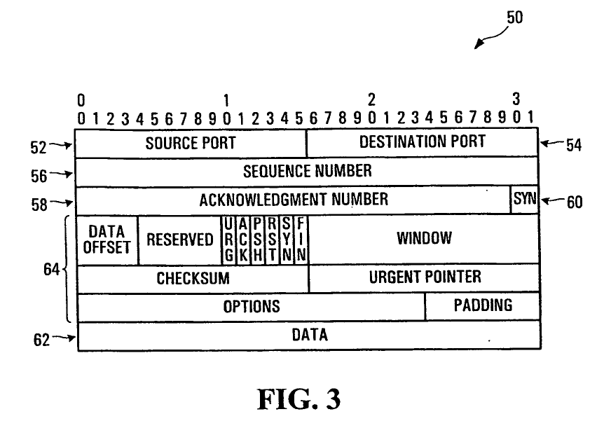

The data of a transport layer packet comprises the application layer (which is typically distributed across a number of transport layer packets). The port number at the transport layer, and/or the context, indicates the application layer protocol. Where the transport protocol is TCP, while the application layer protocol may be any of various application layer protocols, the most important are hyper-text transfer protocol (HTTP), secure HTTP (HTTPS), file transfer protocol (FTP), and simple mail transfer protocol (SMTP).

Where the transport protocol is TCP, the packets transmitted will be sent as internet datagrams. The Internet Protocol header will carry several information fields, including the source and destination IP addresses. A TCP header follows in accordance with the format illustrated in FIG. 3. Thus, each packet 50 includes a source port field 52, a destination port field 54, a sequence number field 56, an acknowledgement number field 58, a synchronisation (SYN) flag 60 and a data area 62, as well as fields indicated generally at 64 for other information.

Whenever one endpoint, such as computer 14, wishes to establish a communication session with another endpoint, such as computer application 22 running on processor 20, an initial packet is sent from computer 14. The source port field 52 of the packet identifies a port on computer 14 which will be used for the session and the destination port field identifies a known port of the application 20 to which the packet can be directed. For the first packet from computer 14 in a session, the SYN flag 60 is set and the sequence number field 56 holds an initial sequence number. The acknowledgement number that computer 14 wishes to be used is stored in acknowledgement number field 58.

When application 22 receives this first packet from computer 14, it may store the initial sequence number and establish a reply packet. The reply packet, being the first packet from application 22, will have the SYN flag set and its own initial sequence number in field 56 and acknowledgement number in field 58. The data of this reply packet will include the acknowledgement number in the first packet from computer 14 to provide an acknowledgement of receipt of this first packet.

Computer 14, on receiving the reply packet, stores the initial sequence number of application 22 then sends back a packet with a sequence number which is an increment of the initial sequence number that computer 14 had supplied in its first packet. The data portion of this packet will include the acknowledgement number in the first packet from application 22 as an acknowledgement of receipt of the first packet from application 22.

The session is now established. Each time computer 14 sends a packet to application 22, the packet will have a sequence number which is incrementally higher than the sequence number sent with the next previous packet sent by computer 14 in the session. Application 22 always stores the last sequence number and compares this with the sequence number of the current packet received. If this new sequence number is an increment of the last sequence number, the new sequence number is simply stored in place of the previous sequence number. However, if the new sequence number is not an increment of the previous sequence number, this indicates that packets are being received out-of-order and the sequence numbers are used to properly order them. Similarly, each time application 22 sends a packet, the packet will have a sequence number which is incrementally higher than the sequence number sent with the next previous packet sent by application 22, and computer 14 always stores the last sequence number and compares this with the sequence number of the current packet received.

If, for any given packet sent by an endpoint in a session, the endpoint does not receive a reply (determined by receiving a packet having an expected acknowledgement number embedded therein) within an expected time, the endpoint will re-send the packet. It will be apparent that this is one way in which packets may end up arriving in a different order at an endpoint.

TCP packets to computer application 22 pass along communication path 24. Since session re-constructor 30 is connected to this communication path; these TCP packets to application 22 are also received by session re-constructor 30. Similarly, TCP packets from application 22 pass not only to the network 12, but also to the session re-constructor.

The session re-constructor constructs sessions with service provider 32 based on the TCP packets directed to application 22. Thus, certain information from packets of an original session with application 22 is copied into new TCP packets forming part of a parallel, but different, session between re-constructor 30 and service provider 32. More specifically, if, for example, processor 16 directs a first TCP packet toward computer application 22 in an attempt to establish a new session, the session re-constructor 30 will receive this packet. From the fact that the SYN flag of the packet will be set, the re-constructor 30 will be aware that this is an attempt to establish a new session. The session re-constructor may create a new column in session table 40 of memory 38, for example, column II. The re-constructor may store the source IP address in a “remote IP addr” row, the source port number in a “remote port no.” row, the initial sequence number of the packet in a “remote seq. no.” row of this column, and the destination port in a “computer app. port no.” row.

Next, the re-constructor constructs a parallel TCP packet and may copy data 62, and other information 64 from the original packet from processor 16 into the parallel packet. The SYN flag 60 of the parallel packet will be set and the re-constructor will select its own initial sequence number for field 56 and acknowledgement number for field 58. The destination port will be a known destination port for service provider 32. This destination port, along with the source port used by the session re-constructor, may be stored in column II of table 40 to facilitate matching of a packet from service provider 32 with the original session to which it relates, for reasons which will be described. The service provider 32 will send a reply packet to the session re-constructor so as to continue establishment of the parallel session, in accordance with the standard manner in which TCP sessions are established.

When the computer application 22 sends a TCP packet to respond to the initial packet from processor 16 in order to continue establishment of the new session, the session re-constructor receives the reply packet and may store into column II the initial sequence number selected by the application. The session re-constructor does not, however, send any parallel packet to service provider 32.

For each subsequent packet from processor 16 relating to the same session, the re-constructor determines the session to which the packet relates by searching session table 40 for a column having a remote IP address matching the source IP address field and a remote port number matching the source port field 52 of the subsequent packet. On finding a match, if the sequence number in field 56 of the subsequent packet is an increment of the pre-existing sequence number in that column, the re-constructor replaces pre-existing sequence number with the sequence number from field 56 of the subsequent packet. The re-constructor also creates a parallel packet, with a copy of the source port, data, and other information of the subsequent packet and directs this parallel packet to the service provider 32. If the sequence number of a packet is not an increment of the pre-existing sequence number stored in the column, the session re-constructor will create a parallel packet with a sequence number having a parallel relationship to the sequence number of the previous packet sent to the service provider. In this way, the service provider may recorder out-of-order packets.

Subsequent packets from the computer application 22 relating to the session are used to update column II of table 40 with the latest sequence number in use by the application for the session. However, no parallel packet is created for the service provider, unless the packet from the application contains control information that modifies the session. More specifically, if the application 22 sends a packet with control information to terminate the session, the re-constructor 30 sends a parallel packet in order to terminate the parallel session with the service provider.

The service provider may be used for a variety of purposes. For example, the service provider may contain rules for screening for illegitimate requests to application 22. A suitable rule set may be created in the manner described in international application no. PCT/CA2003/001507 filed Oct. 1, 2003, the contents of which are incorporated by reference herein. Such a rule set, once created, may screen for illegitimate requests in the manner described in international application no. PCT/CA2003/001333 filed Sep. 12, 2003, the contents of which are incorporated by reference herein.

If the service provider determines that a request (reflected in a series of TCP packets of a session) is illegitimate, it may raise an alarm. Alternatively, or additionally, it may send a packet to the re-constructor 30 which includes control information instructing that the session be terminated. This packet will contain source and destination ports which allow the session re-constructor to access table 40 to determine the column for the original session to which the packet relates. The re-constructor then reads the current remote sequence number from this column and creates a TCP packet directed to processor 16 with this sequence number and with control information requesting termination of the session. Similarly, the re-constructor reads the current computer application sequence number from this column and creates a TCP packet directed to application 22 with this sequence number and with control information requesting termination of the session. Both packets are injected onto communication path 24. In this way, the re-constructor can take down the session between the processor 16 and application 22 that contained the illegitimate request.

It will be apparent from the foregoing that the session re-constructor and service provider work in parallel with the computer application. In consequence, the re-constructor and service provider have no impact on the responsiveness of the application 22 (i.e., they do not bottleneck the application nor decrease its reliability).

Computer application 22 could adapt processor 20 to act as a server to serve browser-based requests from clients. Computer 14 may, for example, be adapted to make such browser-based requests. Alternatively, application 22 may adapt processor 20 to provide web services and processor 16 may, for example, be adapted to request such web services.

In other embodiments, service provider 32 may be adapted to record keeping or evidence collecting functions. For example, service provider 32 may recognise sessions of a certain type, such as e-mail sessions or instance messaging sessions. In such circumstances, the service provider may be used to provide e-mail, or instance message, management services, such as logging numbers of e-mails or screening for events such as e-mails with a sender matching an entry in a stored list of senders. On finding an e-mail matching an entry, the service provider may be adapted to take an appropriate action, such as raising an alert. The service provider could also be a de-bugger: monitoring and re-constructing network communications for purposes of identifying and correcting operational problems.

Notably, for many of the services that may be contemplated for service provider 32, the service provider will need no awareness that it is handling re-constructed sessions rather than original sessions. For example, this will be true for any service which does not need to inject information into the original session, such as a monitoring (e.g., record keeping, evidence collecting, or de-bugging) service. In such instances, any pre-existing standard service provider may be used with session re-constructor 30 without modification to the service provider 32.

Other modifications will be apparent to those skilled in the art and, therefore, the invention is defined in the claims.

What is claimed is:

1. A method for use in a session-oriented network, comprising:
for each session with a given endpoint, said each session comprising packets exchanged between said given endpoint and another endpoint, said packets having one or both of control and payload data, creating a parallel session having payload data mirroring all payload data of said each session which is destined for said given endpoint.

2. The method of claim 1 wherein said each session with a given endpoint is an original session and further comprising:
in a given parallel session, receiving control information; and
for a particular original session from which said given parallel session was derived, injecting said control information in said particular original session directed to said given endpoint and to said another endpoint for said particular original session.

3. The method of claim 2 wherein said creating a parallel session further comprises creating said parallel session having control information mirroring all control information of said each original session.

4. The method of claim 3 wherein said control information injected into said particular original session is a session termination command.

5. The method of claim 4 wherein said network follows internet protocol.

6. The method of claim 5 wherein said network follows transport control protocol.

7. The method of claim 6 further comprising tracking sequence numbers of said particular original session and wherein said injecting said control information in said particular original session comprises injecting control information together with expected sequence numbers.

8. The method of claim 7 wherein said given endpoint is a server for satisfying browser- based requests.

9. The method of claim 7 wherein said given endpoint is a server for providing web services.

10. The method of claim 1 wherein said each session with a given endpoint is an original session and wherein a given parallel session has an initial sequence number differing from an initial sequence number of a particular original session from which said given parallel session was derived.

11. The method of claim 1 further comprising screening said payload data for illegitimate requests.

12. The method of claim 11 wherein said each session with a given endpoint is an original session and further comprising:
on finding an illegitimate request in respect of a given original session, injecting a session termination command into said given original session directed to said given endpoint and to said another endpoint for said particular original session.

13. The method of claim 1 further comprising screening said payload data for events.

14. The method of claim 13 wherein said each session with a given endpoint is an original session and further comprising:
on determining an event in respect of a given original session, logging said event.

15. The method of claim 14 wherein said event is an e-mail message having certain parameters.

16. The method of claim 1 wherein said each session with a given endpoint is an original session and further comprising, where control information in packets of said original session instruct termination of said original session, creating packets in said parallel session with control information to terminate said parallel session.

17. A session re-constructor, comprising:
an interface for connection to a session-oriented network;
an interface for connection to a given endpoint;
a processor for, for each session with said given endpoint, said each session comprising packets exchanged between said given endpoint and another endpoint, said packets having one or both of control and payload data, creating a parallel session having payload data mirroring all payload data of said each session which is destined for said given endpoint.

18. The session re-constructor of claim 17 further comprising a memory storing a table with information on said each session, said information comprising an address of said another endpoint, a port number of said another endpoint, a sequence number of said another endpoint, a port number of said given endpoint, and a sequence number of said given point.

19. A computer readable medium containing computer executable instructions for causing a processor connected into a session-oriented network to:
for each session with a given endpoint, said each session comprising packets exchanged between said given endpoint and another endpoint, said packets having one or both of control and payload data, creating a parallel session having payload data mirroring all payload data of said each session which is destined for said given endpoint.
